(19) United States
(12) Patent Application Publication
(10) Pub. No.: US 2010/0201895 A1
(43) Pub. Date: Aug. 12, 2010

(54) Optical Projection Method And System

(76) Inventor: Michael GOLUB, Rehovot (IL)

Correspondence Address: The Law Office of Michael E. Kondoudis, 888 16th Street, N.W., Suite 800, Washington, DC, 20006, US

(21) Appl. No.: 12/669,135

(22) PCT Filed: Jul. 17, 2008
(86) PCT No.: PCT/IL08/00990

§ 371 Date: Jan. 14, 2010

Related U.S. Application Data
(60) Provisional application No. 60/950,187, filed on Jul. 17, 2007.

(51) Int. Cl. H04N 5/74; H04N 9/31

(52) U.S. Cl. 348/759; 348/744; 348/E05.137; 348/E05.139

(57) ABSTRACT

An image projection system is presented. The system comprises an optical unit and a connectable thereto control unit. The optical unit is configured to define an illumination channel for illuminating an object, an imaging channel for creating an image of the object from light collected therefrom and generating image data indicative thereof, and a projection channel for projecting an image of the object on a projection target. The control unit is configured and operable for receiving and analyzing the image data, and for controlling the image creation and projection.

### CROSS-REFERENCE TO RELATED APPLICATIONS

This application is a National Phase of International Patent Application No. PCT/IL2008/000990, filed Jul. 17, 2008, which claims the benefit of priority from U.S. Provisional Patent Application No. 60/950,187, filed Jul. 17, 2007.

### FIELD OF THE INVENTION

The invention relates to a light projection and imaging method and system.

### BACKGROUND OF THE INVENTION

Image projection techniques are widely used in various applications. Typically, projector devices utilize lasers and/or LEDs and one or more spatial light modulators (SLM), e.g. liquid crystal display (LCDs), or digital micromirror devices (DMD) for creation of real optical image of a digital image data. A projector device may be configured for projecting a colored image.

Various projection techniques, suitable for used in micro-projectors are disclosed for example in WO 04/064410, WO 04/084534, U.S. Pat. No. 7,128,420, WO 07/060,666, WO 05/036211 and WO 08/010,219, all assigned to the assignee of the present application.

### SUMMARY OF THE INVENTION

The invention provides an optical system configured and operable as an imager and as a projector, the system thus being operable independently in the imaging and projection modes. To this end, the system comprises an imaging channel and a projection channel, which in some embodiments are partially overlapping (i.e. have common optical element(s)).

Preferably, such imaging and projection system is configured for projecting, via the projecting channel, an image created in the imaging channel; this created image may be indicative of the image being projected and in addition used for a precise spatial alignment of the object and the projected image. In other words, the system may operate to project image indicative of electronic data corresponding to the previously created image, where the latter may be an image of what has been projected onto a projecting surface. In some embodiments, projected image is further acquired in the imaging channel, as a feedback, for a purpose of precise alignment between the object and the projected image.

Even though projection systems create any image on a screen, the invention in some embodiments thereof provides for projecting an image of an object of interest on a surface of the same object of interest, for highlighting object features. The imaging and projection modes may be implemented with different spectra, for example near IR imaging and visual-spectrum projection. This may for example be used in medical applications by imaging a region of interest in a body by near IR spectrum and projecting this digitally processed image by visual light onto a skin region aligned with said region of interest on the surface or inside the body. Alternatively or additionally, the imaging and projection modes may be performed timely separated or in an interlaced fashion using the same or different spectral ranges of light.

The invention thus considers illumination, imaging, and projection channels as parts of the system. In some embodiments of the invention, illumination and imaging are performed in a first wavelength band (near IR, for example), whereas the projection is performed with a light in a second or more wavelengths bands (visible range, for example), different from the first. Imaging data, which is buried for a human eye but uncovered in a first wavelength band, is used to visualize, with the projection channel, in second wavelength band(s), features of the object of interest (which may be the image projected by the same system onto a projecting surface). The first wavelength range illumination should preferably be treated as a projection of uniform irradiation pattern, with well defined shape, on the surface of an object of interest and well defined polarization state. Consequently, a source of IR light is spatially shaped and delivered to the object of interest with relatively uniform irradiance distribution. Provided that projection system already has a dedicated projection lens, the first wavelength band illumination may be directed through the projection lens. Further, the same projection lens may be used, in inverted ray directions, for imaging the object onto an image sensor, with polarization state different from that of the illumination, such that the polarization changes are introduced by the object.

Combining of illumination, projection and imaging channels in an integral system results in efficient utilization of illumination radiation and substantial power savings. Furthermore, the system becomes compact due to reduction of number and power of illumination sources. Power saving and compactness are especially important for portable battery operated interactive projection systems.

In some embodiments of the invention, lasers or LEDs are used as the illumination and projection sources. In an application of visualization of human vein structure, a harmless near infrared light source illuminates the tissue. Illumination light penetrates on the depth of several millimeters inside the tissue surrounding the vein and is reflected back to the surface, while substantially less light is reflected back from the blood inside the vessel. The polarization state of the illumination light might be changed after interaction with the object, for example, with human vein structure. The digital video camera captures a predefined polarization component of the near-infrared light reflected back from the tissue. Image processing unit improves contrast and projects this image back on the skin preferably in registration of a lateral position with the actual location. The image projector may utilize DMD technology, LCD microdisplays or LCOS technology to display focused images of the vasculature onto the surface of the skin.

The invention also provides for dynamic and inherent registration between a lateral position of the projected image and a lateral position of the surface of the object of interest. This is carried out by monitoring, with the same image sensor, images of the object of interest, acquired both in the first and second wavelength bands. It should be noted that this technique is beneficial both to systems that do and do not combine (integrate) illumination, projection and imaging channels, as disclosed in the previous paragraph.

This may be achieved by either temporal or spatial splitting of illumination and projection wavelength bands. In the case of temporal splitting, illumination and projection light sources are activated in a time sequential mode, and the image sensor has a wide spectral sensitivity, which is sufficient to detect both illumination and projection wavelength bands. Image sensor is synchronized with the time sequence of light sources activation. In the case of spatial splitting, image sensor has a generalized wavelength sensitivity mosaic. Herein, the sensor is composed of pixels sensitive to the first wavelength band, and, interlaced with them, pixels sensitive to the second wavelength band. The illumination and projection light sources can be arbitrarily activated.

Thus, according to a broad aspect of the invention, there is provided a system for projection an image. The system comprises an optical unit and connectable thereto control unit. The optical unit is configured to define an illumination channel for illuminating an object, an imaging channel for creating an image of the object from light collected therefrom and generating image data indicative thereof, and a projection channel for projecting an image of the object on a projection target. The control unit is configured and operable for receiving and analyzing the image data, and for controlling the image creation and projection.

In some embodiments of the invention, the illumination and imaging channels are defined by an imaging unit which comprises a light source unit generating light of at least one first wavelength range, an image sensor, and light collecting and directing arrangement. The latter might comprise a polarization beam splitter to separate the polarization state of the illumination and the polarization state of the imaging in the first wavelength range. The projection channel is defined by a projection unit comprising one or more light source units generating light of at least one second wavelength range different from the first wavelength range, a spatial light modulator (SLM) and light collecting and directing arrangement.

In some embodiments of the invention, the system is configured such that the imaging channel images the object of interest located at the projection target. The control unit is adapted for analyzing the image data and operating light propagation through the projection channel to create, on the projection target, an image corresponding to said image data. In some embodiments, the control unit is adapted for analyzing the image data of the object created by light of the first wavelength range to operate the projection of a corresponding image using light of the second wavelength range. Further to that, in some embodiments, the control unit is adapted for analyzing the image data of the object created by light of the second wavelength range to ensure mutual alignment of the object and corresponding projected image in the second wavelength range.

The system may be configured such that the illumination, imaging and projection channels are spatially separated; and/or the imaging and projection channels are at least partially overlapping; and/or the illumination channel is spatially separated from the imaging and projection channels or at least partially overlapping with the projection channel. The illumination channel may be configured to provide polarization coding of light used for imaging the object.

The optical unit may include a light source assembly, a light directing arrangement, and an image sensor. The light source assembly may include a first light source unit producing light of a first wavelength range propagating through the illumination channel, and a second light source unit producing light of a second wavelength range different from the first wavelength range. The light directing arrangement may be configured for directing the first wavelength light along a first path within the illumination channel to illuminate the object located at the projection target, directing the second wavelength light along a second path within the projection channel towards a spatial light modulator (SLM), and for collecting the first wavelength light propagating from the illuminated object along a third path within the imaging channel.

In some embodiments, the light directing arrangement comprises a polarizer located in the illumination channel, and a polarization filter located in the imaging channel. The light directing arrangement may comprise a common projecting and imaging lens unit accommodated in the imaging and projection channels and operating for collecting the first wavelength light propagating from the illuminated object and for imaging the second wavelength light modulated by the SLM onto the projection target, and comprises a common beam splitter/combiner accommodated in the imaging and projection channels and spatially separating the first and second wavelength light portions and directing them towards respectively the image sensor and the projecting and imaging lens unit.

In the above configuration, the illumination channel may be spatially separated from the imaging and projection channels, or may be at least partially combined with the imaging channel. In the latter case, the light directing arrangement preferably comprises a polarizing beam splitter located in the combined illumination and imaging channels being in the optical path of the first wavelength light propagating to the object and the first wavelength light returned from the object. The illumination channel may be configured to provide ring-like first wavelength beam, to thereby enabling spatial separation between the first wavelength illuminating and returned light, for enhanced splitting between the illumination and imaging channels.

According to another aspect of the invention, there is provided a method for projecting an image. The method comprises imaging an object, located at a projection target, onto an imaging sensor using a first wavelength range, generating image data indicative thereof, and using the image data for projecting onto a projection target an image formed by light of a second different wavelength range modulated in accordance with said image data.

Thus, in some embodiment of the invention, the method of interactive light projection is provided. According to this method, spatial shaping of illumination radiation with wavelengths in the first wavelength range and delivering said radiation to an object of interest, which possesses feature details and a surface is provided. Radiation returned from the object of interest in said first wavelength range is acquired, and a digital image of the object is formed. This digital acquired image is processed with extracting and contrasting of feature details. Spatial modulation of the projection light in accordance with said acquired image is carried out, and the spatially modulated light is projected as a projected image onto the surface of the object of interest, with the projection light having wavelength in projection wavelength ranges, including at least the second wavelength band and optionally several other wavelength ranges, all of them different from the first wavelength range. The position of the projected image is adjusted along the surface of the object of interest, up to having said position in match to the feature details of the object of interest. Here, illumination radiation is being superimposed with projection light in course of stages starting from a superposition stage and ending in delivering illumination radiation and projection light to an object of interest. The superposition stage follows spatial modulation of projection light and precedes projection of the spatially modulated light onto the object of interest.

As indicated above, in some embodiments, illumination radiation is essentially spatially separated from the projection light.

The method of interactive light projection of the present invention may include: illumination, comprising spatial shaping of illumination radiation with wavelengths in the first wavelength range and delivering said radiation to an object of interest, which possess feature details and a surface; acquiring radiation returned from the object of interest in the first wavelength range and formation of a digital image of the object; processing the digital acquired image with extracting and contrasting of feature details; spatial modulation of projection light in accordance with said acquired image; projection of the spatially modulated light as a projected image onto the surface of the object of interest, with the projection light having wavelength in the second projection wavelength range(s) different from the first wavelength band; adjustment of the position of the projected image along the surface of the object of interest, up to having said position in match to the feature details of the object of interest. A secondary imaging of a projected image from the surface of the object of interest may be further provided in a sampled wavelength range which includes the second wavelength range and optionally several other wavelength ranges. Feedback-type correction of a position of the projected image relative to the object of interest can be performed in accordance with mismatch between the actual lateral image position in the first and sampled wavelength range. Here, the illumination and projection stages may be temporally split, i.e. executed in time sequential frames divided to subframes, without overlap in time between illumination and projection, and acquiring of radiation in the first wavelength range may be synchronized in time with subframes of illumination, and acquiring of light in the sampled wavelength range may be synchronized in time with subframes of projection. Alternatively, the process of acquiring the digital image in the first wavelength range may be spatially split from the process of acquiring the digital image in the sampled wavelength range, i.e. executed by the image sensor with pixels that are spatially divided to several sub-pixels.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic illustration of an example of a projection and imaging system of the present invention, utilizing a separate illumination channel and partially overlapping imaging and projection channels;

FIG. 2 shows a specific example of the optical scheme for the partially combined imaging and projection channels suitable to be used in the system of FIG. 1;

FIGS. 3A-3B and 4A-4B exemplify the system performance data, where FIGS. 3A-3B show polychromatic diffraction MTF in the imaging and projection channels and

FIGS. 4A-4B show encircled energy in the imaging and projection channels;

FIGS. 5 to 7 show three more examples, respectively of the projection/imaging system of the present invention, where FIGS. 5 and 6 show two examples of the system with partially overlapping illumination, imaging and projection channels and FIG. 7 shows the system where such channels are non-overlapping;

FIGS. 8A and 8B show the principles of time sequential activation of illumination, projection and imaging light sources on a shared image sensor, suitable to be used in the system of the invention; and

FIGS. 9A-9D show the principles of mosaic transverse structure of an imaging sensor array for parallel imaging of both the first wavelength range (exemplary IR) and the second wavelength range (exemplary visible image, suitable to be used in the system of the invention.

### DETAILED DESCRIPTION OF EMBODIMENTS

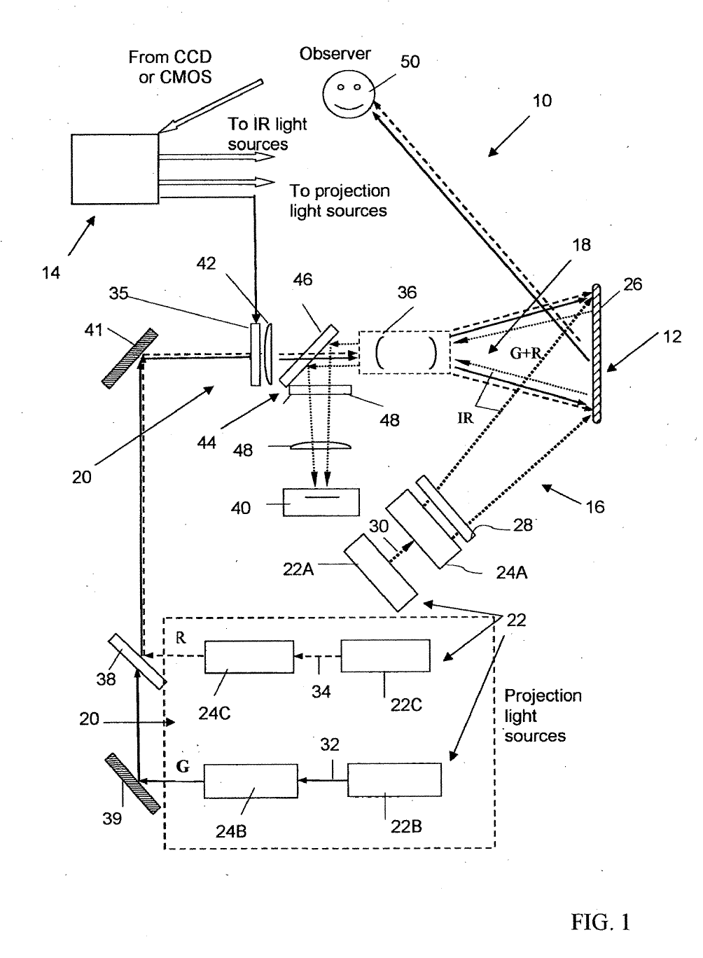

Reference is made to FIG. 1 showing schematically an example of a system, generally designated 10, configured and operable as an imager and projector according to the invention, namely utilizing an interacting light projection display with combined path of projection and imaging. The system 10 includes such main constructional parts as an optical unit 12 and a control unit 14.

The optical unit 12 is configured to define an illumination channel 16, an imaging channel 18, and a projection channel 20 which may or may not be at least partially overlapping (combined) as will be described further below. The imaging channel 18 is configured for creating an image of an object of interest, which is located in a projecting plane 26 and is illuminated via the illumination channel, and generating corresponding image data. The projection channel 20 is configured for projecting an image of an object onto a region of interest (or projection target) in the projecting plane 26, the projected image being formed by appropriate spatial modulation of light coming from the illumination channel. As exemplified in FIG. 1, said projection target created by the projection channel may constitute an object of interest for the imaging channel.

The optical unit 12 includes a light source assembly 22 associated with the illumination channel 16 and the projection channel 20. In the present example, the light source assembly 22 is configured for producing light of different wavelengths, three such wavelengths in the present example, being in two different spectra—one in the IR spectrum and two (green G and red R) in the visual spectrum. Light portions of these two different spectral ranges are directed to respectively the imaging and projection channels. The light portions of different spectral ranges are directed along respectively illumination and projection channels 16 and 20. Thus, in this example, light source assembly 22 comprises IR illumination light sources 22A (which may be LED or laser diode), and Green and Red light sources 22B and 22C, associated with their respective beam collection and shaping optics 24A, 24B and 24C. Also, in the present example, imaging and projection channels are partially overlapping, i.e. have a combined optical path defined by common optical elements (lens unit and beam splitter/combiner).

Thus, the optical unit 12 includes a projection unit and an imaging unit. The projection unit defines the projection channel 20 and includes its own light source unit (including one or more light sources 22B, 22C), spatial light modulator (SLM) 35 and light directing optics. The imaging unit defines the illumination and imaging channels 16 and 18 and includes light source unit 22A, an image sensor 40, and light directing optics.

The optical unit 12 is configured to separate IR light components of incident (illuminating) light propagating from the light source 22 towards the object 26 and IR light component returned (reflected/scattered) from the object and propagating towards imaging detector 40 (CCD or CMOS). In the present example, this is achieved by using polarization coding of IR illumination: a polarizer 28 in the illumination channel, in the optical path of light 30 emitted by the IR light source 22A and propagating towards the object.

Projection channel 20 has projection light sources 22B, 22C, beam collection and shaping optics 24B, 24C, spatial light modulator (SLM) 35, and projection lens unit 36. The beam collection and shaping optics provides essentially uniform intensity and high degree of collimation of the projection light, and can be implemented as a beam homogenizer with tandem microlens arrays or, alternatively as a top-hat diffractive optical element. It should be noted that generally, for projection of colored images, the projection channel may utilize separate SLMs for different colors and be configured for combining the modulated light of different colors to propagate along a combined optical path. In the present example, however, the common SLM unit 35 is used and the light components 32 and 34 of different colors are combined by a wavelength-selective beam splitter combiner (e.g. dichroic mirror) 38. Also optionally provided in the projection channel are light directing/deflecting elements (e.g. mirrors) 39, 41 and a projection enhancement lens unit 42.

Imaging channel 18 comprises collection lens unit 36 (which is common with the projection channel) and image sensor 40. Also provided in the imaging channel is a spectral filter assembly 44 which separates (filters) from the collected light that of the specific wavelength range (IR in the present example) and directs it to the image sensor, thus preventing detection by the sensor of light outside said wavelength range. In the present example, such spectral filter assembly includes a wavelength selective beam splitter combiner 46 (hot mirror) which is common with the projection channel and operates for spatially separating between the light portions of the imaging and projection channels. A further filter unit 48 is preferably used at the output of the hot mirror; this filter transmits IR radiation and has polarization properties (as indicated above polarization state of the IR light incident onto the object is appropriately adjusted by polarizer 28 in the illumination channel). Optionally provided in the imaging channel is an image enhancement lens 49. Thus, imaging channel 18 makes use of projection lens 36, in inversed ray direction, as an IR camera lens, and is optically connected to the projection lens by hot mirror 46.

Control unit 14 is typically a computer system comprising inter alia an electronic processing and synchronization block which receives and processes image data from image sensor 40 (CCD or CMOS), and generates control data (e.g. modulation data) to at least some of the light sources. System 10 may thus operate as follows.

An object located in the projecting plane (e.g. within the projection target region) is imaged onto the CCD 40: the object is illuminated by “imaging” light 30, e.g. IR light; light 30 returned from the illuminated object is collected by lend unit 36, and reflected by hot mirror 46 towards filter 48, which transmits this light to CCD 40 via image enhancement lens 49. CCD outputs corresponding image data to the control unit 14. The latter actuates the projection channel to project a corresponding projection target on the projecting plane: actuates light sources 22B, 22C to generate green and red light components 32, 34 and operates the SLM unit 35 in accordance with the image data. Light component 32, 34 propagate (light component 34—directly, and light component 32—via mirror 39) towards dichroic mirror 38, which combines them and directs to SLM 35 (via mirror 41); resulted modulated light sequentially passes through projection enhancement lens 42, hot mirror 46 and projection lens 36 and is directed to the projection target to be viewed by an observer 50.

In a medical application for example, camera 40 (CCD or CMOS) takes an infra red picture from a part of buried features of the tissue of a human body, while the projector channel creates a visible picture on the same area showing details can not be seen by naked eye, such blood vessels and veins. The light from IR illumination channel reaches the object of interest, for example a human tissue, penetrates to the depth of several millimeters and is being reflected or back-scattered. The reflected light is acquired by camera lens 36, which is in turn the projection lens, reflected from the hot mirror 46, passes through the filter 48 which transmits light in IR illumination range, with polarization state orthogonal to that of IR illumination radiation. Aberrations of the image, that might occur due to the use of a common projection and imaging lens 36, can be essentially corrected by the image enhancement lens 49. Finally a focused image of the object of interest, in the IR illumination radiation, is obtained on the image sensor, converted to a digital form and digitally processed, for contrasting, by the electronic block. The contrasted image is then transferred to the SLM, which spatially modulates the light delivered by the beam collection and shaping optics of the projection channel. The spatially modulated light passes through the hot mirror and is then imaged by the projection lens on the surface of the object of interest. Optional projection enhancement lens corrects residue aberrations of the projection lens, which is designed to serve also as a camera lens in the imaging channel. Position of the image of spatially modulated light on the surface of the object of interest is matched to said object of interest by monitoring of scale and position of feature details in the image and the object of interest. In one option, match is performed by visual inspection. In another option the match is performed by application of a visible-to-IR conversion plate in front contact with the object.

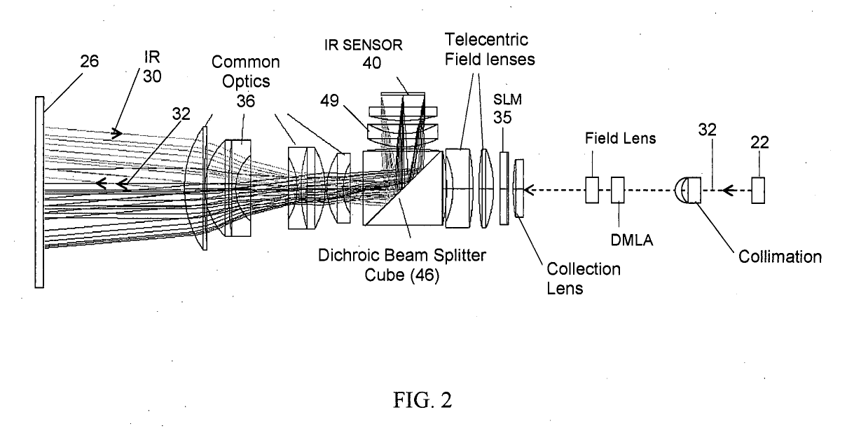

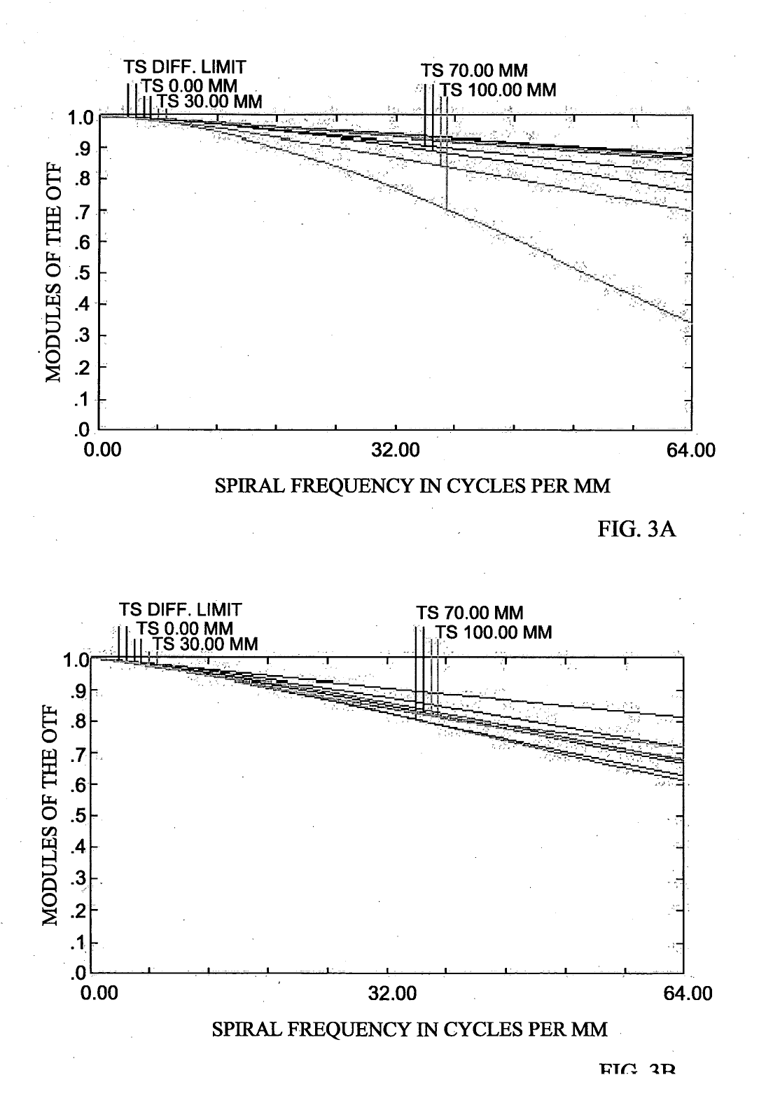

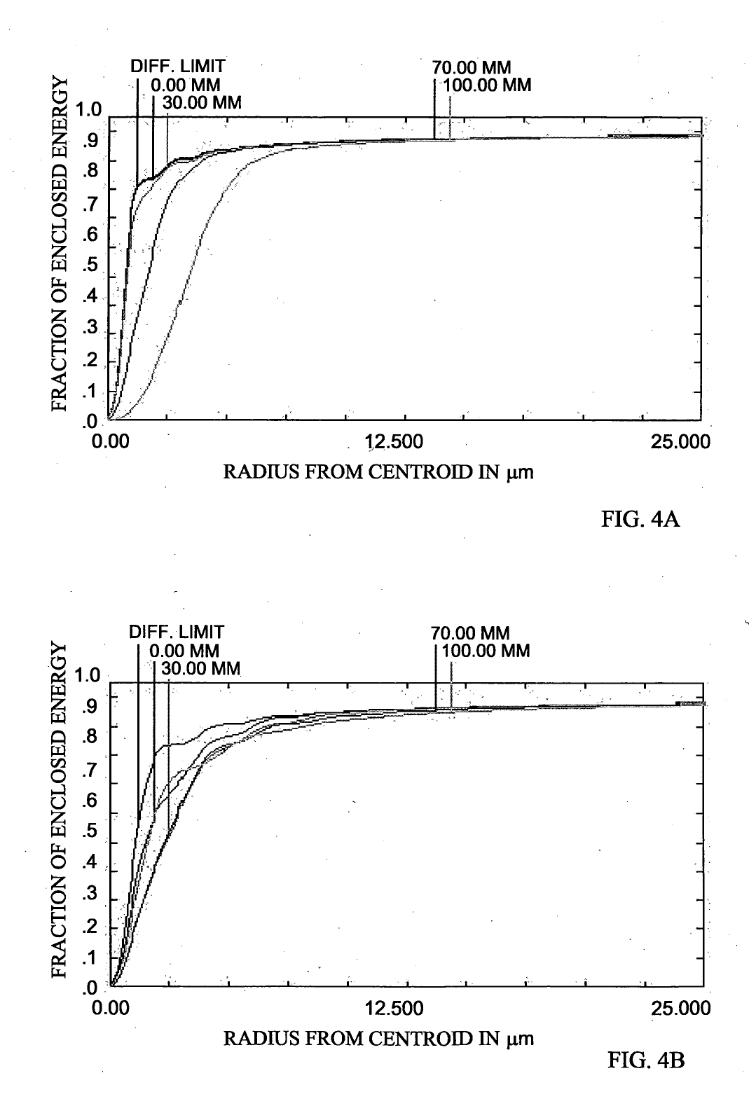

Thus, the above described embodiment includes designed data for with combined path of projection and imaging. Reference is made to FIG. 2 exemplifies a specific but not limiting configuration for the combined (partially overlapping) imaging and projection channels, where only one of the projection color sub-channels is shown. As shown, green light 32 propagates from green light source 22B and is directed by a collimation lens unit, DMLA, field lens and collection lens (constituting collection, beam shaping and de-speckling optics) onto SLM 35. Light output from the SLM is directed e.g. by a telecentric field lenses onto a dichroic beam splitter cube (hot mirror) 46, which reflects transmits this light, via common projection and imaging optics 36, onto the projection target 26. Concurrently, or before or after the projection procedure, as the case may be, IR light illuminates the projection target (not shown here) and light returned from the illuminated region is collected by common projection and imaging optics 36 towards the hot mirror 46 which reflects it to the IR sensor 40 (via image enhancement lenses).

It should be noted that projector light source (22 in FIG. 1) may be a collimated laser or LED beam, expanded, shaped, de-speckled and homogenized by beam shaping optics (24B, 24C in FIG. 1), which includes field lens and collimator. Focal length of collimator lens times the F# of DMLA determines the dimensions of illumination rectangular spot on the SLM. The incidence angles at the SLM should preferably be below the angular range of acceptance typical for the SLM, that is about 7-9 degrees for the case of LCD or LCOS SML and 12-15 degrees for the DMD SLM, thus improving efficiency and contrast. Using the X-cube enables to combine RGB (or other colors) as an alternative to the dichroic mirrors 38, 41 as depicted in FIG. 1.

The inventors have designed an experimental optical system, and operated to examine the system performance. The performance data (polychromatic diffraction MTF in the imaging and projection channels encircled energy in the imaging and projection channels, optical path difference in imaging and projection channels, transverse aberrations plot in imaging and projection channels, and field curvature and dispersion plot in imaging and projection channels) has shown the feasibility of the invented approach. The experimental set up was configured similar to the system of FIG. 1. Design preferences were the following: Since camera sensor and projector SLM are not necessarily with the same dimensions, and the field of view of both channels are to be equal, a different focal length for each channel may be used by changing 2 lenses after the beam splitter/combiner cube. Projection lens is telecentric in order to have best efficiency on light gathering from SLM. There is no such requirement on the camera channel. The two lenses between SLM and beam splitter/combiner cube act as telecentric field lens. Cube beam splitter inserted inside the lens assembly. Using simple plane hot mirror as dichroic beam splitter/combiner would cause comma aberration to the projection channel while cube is symmetrical and when taken into account during design enables better optical performances. The rear and upper sides of the cube are spherical optical surfaces and used as part of optical system in order to reduce the number of components.

As indicated above, the focal length of collimator lens times the F# of DMLA determines the dimensions of illumination rectangular spot on the SLM. Thus, the experimental set up is designed to have this spot matching the dimensions of the active area of SLM (surface defined by the pixel arrangement/matrix) in order to get maximum efficiency and uniformity; design keeps lower angles of illumination at the SLM to thereby improve the efficiency and contrast.

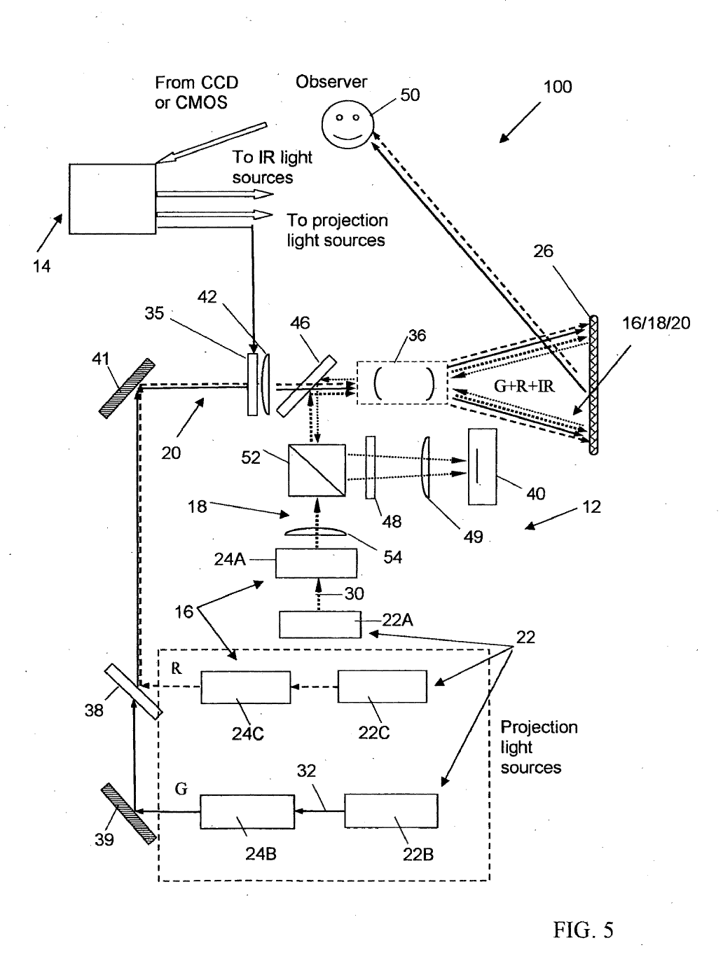

Reference is made to FIG. 5 showing schematically another example of a projection and imaging system, generally designated 100, according to the invention. The same reference numbers are used for identifying components that are common in all the examples. As shown, system 100 is generally similar to the above described system 10, but distinguishes therefrom in that it has partial overlap (combined path) of illumination, imaging and projection channels 16, 18 and 20. This raises optical efficiency of the system and makes illumination channel substantially more compact.

In the above-described system 10, the separation of IR light components of incident and collected light is carried out using spatial separation between the illumination and imaging channels and polarization coding of the incident IR light portion (polarizer 28 in the illumination channel and appropriate filter 48 in the imaging channel). Optionally provided in system 100 is an illumination enhancement lens 54. In the system 100, combining (partial) of the illumination channel with the imaging and projection channels is enabled by using a polarizing beam splitter 52 for wavelengths in a first wavelength range, which is optically connected with the beam combiner (hot mirror) 46 in match to polarization of illumination radiation and also optically connected with image sensor 40 (with optional image enhancement lens 49).

Polarization beam splitter 52 naturally ensures a use of orthogonal polarizations for illumination and imaging that prevents from bright spots and glares in image which may be provided by illumination. Polarization beam splitter 52 may be implemented as a polarizing beam splitting cube or, alternatively, as a 45 degree wire-grid polarizer, as well as multiple wavelength diffractive beam splitter/combiner. System 100 operates similar to the above described system 10.

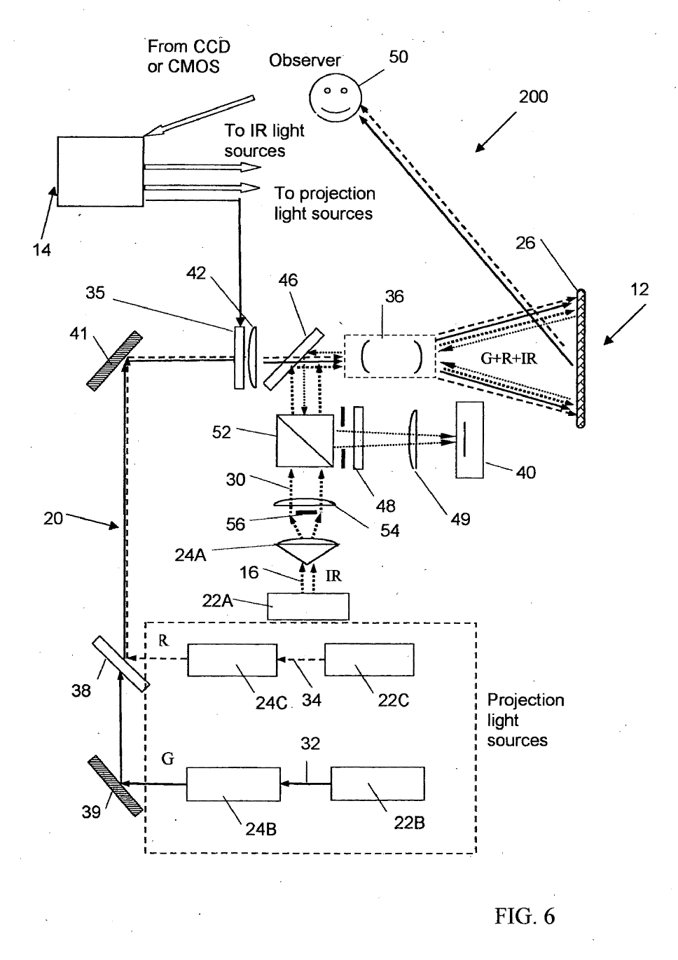

FIG. 6 shows yet further example of a projection/imaging system 200 of the present invention. Here, separation of illumination and imaging IR radiation components is further improved by annular peripheral illumination channel optical scheme. System 200 distinguishes from the above described system 100 in that its beam collector and shaper 24A, located in the illumination channel, in the optical path of light (IR light) propagating from the light emitter 22A, is configured to provide a ring-like IR illumination. In the present example, this is achieved by using a lens 58 and a light blocking diaphragm 56 accommodated downstream of the lens (in the direction of light propagation through the illumination channel so as to block light emerging from the central region of the lens and thus create a ring-light illumination formed by light coming from the peripheral region of the lens. Thus, illumination radiation 30 essentially passes through a peripheral (ring-like) section of the polarizing beam splitter/combiner 52 and is further reflected by a corresponding portion of hot mirror 46 and passes through the peripheral ring-like portion of projection lens 36, whereas radiation returned from the object of interest essentially passes through a central part of the projection lens 36 and that of the beam combiner 52 being then blocked by light blocking diaphragm 56. This configuration provides for reduced cross talk between illumination and imaging channels.

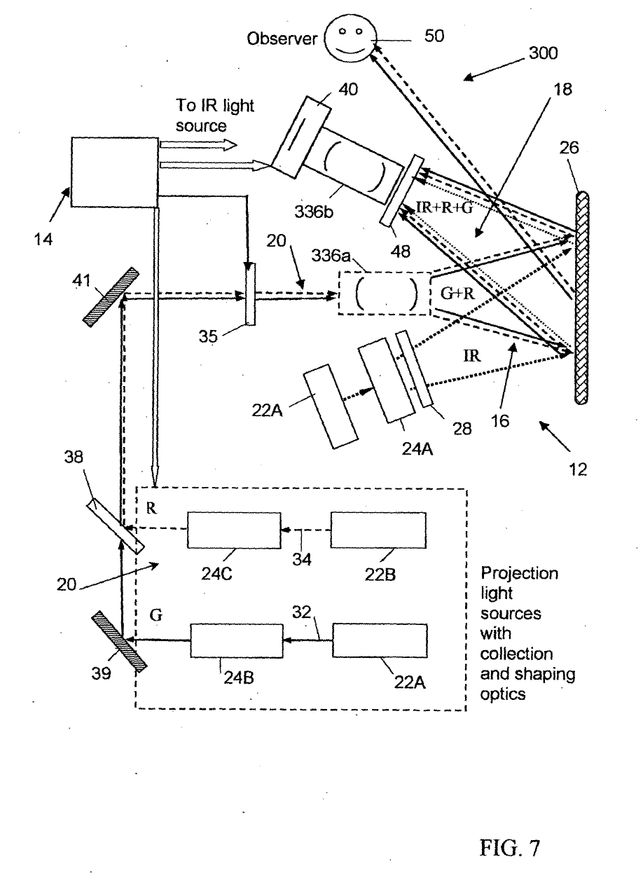

Referring to FIG. 7, there is illustrated yet further example of a projection/imaging system 300 of the present invention, which is generally similar to the above-described system 10 (FIG. 1), but differs therefrom in that here additional imaging of projected visible (G,R) light from the surface of an object of interest 26 to the same imaging channel as used for IR radiation is provided using separated (non-overlapping) illumination, imaging and projection channels 16, 18, 20. This configuration allows for further improving match in scale and alignment between a projected image and the features of an object of interest. Thus, there are no common optical elements in the IR illumination channel 16, imaging channel 18 and projection channel 20. Illuminating and reflected IR components are separated using polarization coding: polarizer 28 in the illumination channel 16 and filter-polarizer 48 in the imaging channel. Common projection and imaging lens 36 in system 10 is replaced here by separate lenses 336A and 336B located in the projection and imaging channels respectively. Image sensor acquires, in addition, light at projection wavelength ranges and projection image is fitted to the feature details of the object of interest. For these, there are several options. For example, time sequential pulsed operation of IR illumination, acquiring IR image and visible projected image read by image sensor in time frames different from reading IR image can be used, or mosaic IR and visible image sensor can be used to split between IR and visible image.

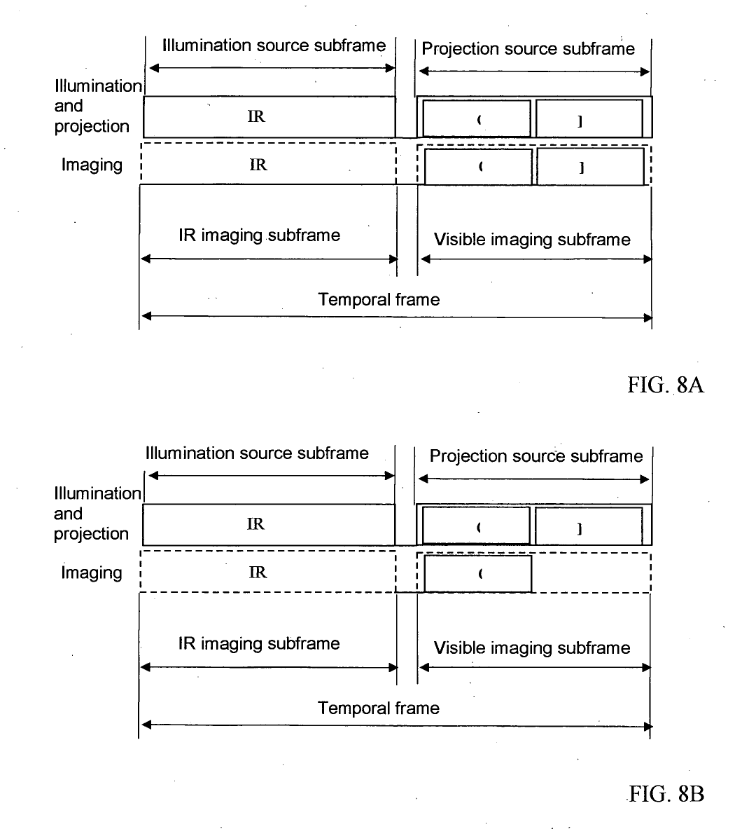

FIGS. 8A and 8B exemplify the principles of time sequential activation of illumination, projection and imaging light sources on a shared image sensor. Illumination light source is activated in the discreet time subframes, when the projection light is not activated.

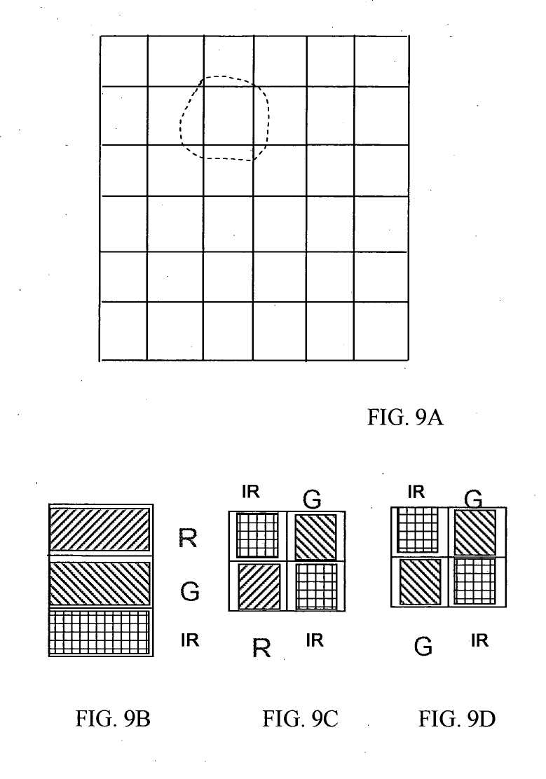

FIGS. 9A-9D exemplify the principles of mosaic transverse structure of an imaging sensor array for parallel imaging of both IR and visible image. Mosaic structure has subpixels with different filters within each pixel of the image sensor, such that one filter type allows to acquire the light of the first wavelength range and other filter—of the second wavelength range.

Thus, the present invention provides a novel combined projection and imaging system, which can be configured as a stand alone system or integrated in any other electronic system. The invention can advantageously be used in various applications, including medical ones.

Those skilled in the art will readily appreciate that various modifications and changes can be applied to the embodiments of the invention as hereinbefore described without departing from its scope defined in and by the appended claims.

1. A system for projection an image comprising:
an optical unit configured to define an illumination channel for illuminating an object, an imaging channel for creating an image of the object from light collected therefrom and generating image data indicative thereof, and a projection channel for projecting an image of the object on a projection target; and
a control unit configured and operable for receiving and analyzing the image data, and for controlling the image creation and projection.

2. The system of claim 1, wherein the illumination and imaging channels are defined by an imaging unit comprising a light source unit generating light of at least one first wavelength range, an image sensor, and light collecting and directing arrangement.

3. The system of claim 1 or 2, wherein the projection channel is defined by a projection unit comprising one or more light source units generating light of at least one second wavelength range different from the first wavelength range, a spatial light modulator (SLM) and light collecting and directing arrangement.

4. The system of any one of the preceding claims, wherein the imaging channel is configured for imaging the object of interest located at the projection target.

5. The system of claim 4, wherein the control unit is adapted for analyzing the image data and operating light propagation through the projection channel to create, on the projection target, an image corresponding to said image data.

6. The system of claim 3, wherein the control unit is adapted for analyzing the image data of the object created by light of the first wavelength range to operate the projection of a corresponding image using light of the second wavelength range.

7. The system of any one of the preceding claims, wherein the illumination, imaging and projection channels are spatially separated.

8. The system of any one of claims 1 to 6, wherein the imaging and projection channels are at least partially overlapping.

9. The system of claim 8, wherein the illumination channel is spatially separated from the imaging and projection channels.

10. The system of claim 8, wherein the illumination channel is at least partially overlapping with the imaging and projection channels.

11. The system of any one of the preceding claims, wherein the illumination channel is configured to provide polarization coding of light used for imaging the object.

12. The system of any one of the preceding claims, wherein the optical unit comprises:
a light source assembly including a first light source unit producing light of a first wavelength range propagating through the illumination channel, and a second light source unit producing light of a second wavelength range different from the first wavelength range;
a light directing arrangement configured for directing the first wavelength light along a first path within the illumination channel to illuminate the object located at the projection target, directing the second wavelength light along a second path within the projection channel towards a spatial light modulator (SLM), and for collecting the first wavelength light propagating from the illuminated object along a third path within the imaging channel; and
an image sensor configured for receiving the collected first wavelength light and generating the image data indicative thereof.

13. The system of claim 12, wherein said light directing arrangement comprises a polarizer located in the illumination channel, and a polarization filter located in the imaging channel.

14. The system of claim 12 or 13, wherein the light directing arrangement comprises a common projecting and imaging lens unit accommodated in the imaging and projection channels and operating for collecting the first wavelength light propagating from the illuminated object and for focusing the second wavelength light modulated by the SLM onto the projection target, and comprises a common wavelength sensitive beam splitter/combiner accommodated in the imaging and projection channels and spatially separating the first and second wavelength light portions and directing them towards respectively the image sensor and the projecting and imaging lens unit.

15. The system of claim 14, wherein the illumination channel is spatially separated from the imaging and projection channels.

16. The system of claim 14, wherein the illumination channel is at least partially combined with the imaging channel.

17. The system of claim 16, wherein said light directing arrangement comprises a polarizing beam splitter located in the combined illumination and imaging channels being in the optical path of the first wavelength light propagating to the object and the first wavelength light returned from the object.

18. The system of claim 16 or 17, wherein the illumination channel is configured to provide ring-like spatial configuration in the cross-section of the beam at first wavelength range.

19. The system of any one of claims 2 to 18, wherein the first wavelength range includes IR range, and the second wavelength range include visual spectrum.

20. An optical unit comprising: an imaging unit configured and operable to define an illumination channel for illuminating an object and an imaging channel for creating an image of the object from light collected therefrom and to generate image data indicative thereof; and a projection unit configured and operable to define a projection channel for projecting an image of the object on a projection target, at least two of the illumination, imaging and projection channels being at least partially combined via common one or more optical elements.

21. The optical unit of claim 20, comprising a light source assembly comprising a light source unit generating light of a first wavelength range and one or more light source units for generating light of a second different wavelength range.

22. A method for projecting an image, the method comprising imaging an object, located at a projection target, onto an imaging sensor using a first wavelength range, generating image data indicative thereof, and using the image data for projecting onto a projection target an image formed by light of a second different wavelength range modulated in accordance with said image data.

23. The method of claim 22, comprising additional imaging of an object, located at a projection target, using the second wavelength range and using additional image data indicative thereof for mutual alignment of the projected image formed by light of a second wavelength range with the object, located at a projection target.
